(19) United States
(12) Patent Application Publication
(10) Pub. No.: US 2025/0116293 A1
(43) Pub. Date: Apr. 10, 2025

(54) BUSH

(71) Applicants: Hyundai Motor Company, Seoul (KR); Kia Corporation, Seoul (KR); Daeheung R&T Co., Ltd., Gimhae-si (KR)

(72) Inventors: Jong Chan Baek, Siheung-si (KR); Dae Ki Jeong, Hwaseong-si (KR); Su Jin Lee, Seoul (KR); Gi Ryung Jung, Hwaseong-si (KR); Yeon Seo Kim, Hwaseong-si (KR); Dong Kil Lee, Gimhae-si (KR); Sung Wook Park, Busan (KR)

(21) Appl. No.: 18/407,858

(22) Filed: Jan. 9, 2024

(30) Foreign Application Priority Data
Oct. 10, 2023 (KR) 10-2023-0134252

(51) Int. Cl. F16C 17/02

(52) U.S. Cl. CPC F16C 17/02; F16C 2326/05

(57) ABSTRACT

An embodiment bush includes a side stopper portion including a first shock absorbing portion, a main body portion including a second shock absorbing portion, wherein the first shock absorbing portion and the second shock absorbing portion are provided discontinuously, and a housing portion configured to couple the side stopper portion to the main body portion.

### CROSS-REFERENCE TO RELATED APPLICATIONS

This application claims the benefit of Korean Patent Application No. 10-2023-0134252, filed on Oct. 10, 2023, which application is hereby incorporated herein by reference.

### TECHNICAL FIELD

The present disclosure relates to a bush.

### BACKGROUND

A suspension device of a vehicle is a device that absorbs shocks or vibrations generated during driving to not be directly transmitted to a vehicle body or passengers, thus affecting the ride comfort and stability of the vehicle.

A suspension device applied to a vehicle may include a MacPherson strut, a double wishbone, a multilink, and a coupled torsion beam axle (CTBA), depending on a structure thereof.

Here, since the CTBA has the advantage of having a simple structure and a small number of components, while occupying less space, the CTBA may be applied to a large number of vehicles. The CTBA is equipped with a bush having elasticity in a portion thereof coupled to a vehicle body to provide a more comfortable ride by buffering some of loads or vibrations generated in front and rear directions of the vehicle.

The bush serves not only to support a connection between the CTBA and the vehicle body, but also to absorb shocks, vibrations, and noise generated by a suspension or an engine, through elastic deformation thereof.

Recently, a bush configured to seal a fluid capable of implementing an active buffer function to have appropriate rigidity suitable for a driving situation of a vehicle has been developed and installed. However, since a conventional bush was manufactured integrally, there may be problems such as difficulty in propagating cracks and improving performance.

### SUMMARY

An embodiment of the present disclosure can solve at least some of the problems of the conventional art, and embodiments provide a bush in which a side stopper portion and a main body portion are separately provided.

According to an embodiment of the present disclosure, a bush may include a side stopper portion provided with a first shock absorbing portion, a main body portion provided with a second shock absorbing portion, and a housing portion configured to couple the side stopper portion to the main body portion, and the first shock absorbing portion and the second shock absorbing portion may be provided discontinuously.

The first shock absorbing portion and the second shock absorbing portion may be formed of materials having different properties.

The side stopper portion may have an upper plate and a lower plate, and the first shock absorbing portion may be provided between the upper plate and the lower plate.

The main body portion may include an inner pipe protruding to one side, and a protrusion of the inner pipe may be inserted into the side stopper portion.

An end of the protrusion of the inner pipe may be in contact with the upper plate.

The upper plate further may include a first protrusion protruding toward the first shock absorbing portion.

The housing portion may further include a fixed portion bent in a “U” shape surrounding an external peripheral surface of the lower plate.

The main body portion may further include a third shock absorbing portion protruding toward an opposite side of the side stopper portion.

The third shock absorbing portion may further include a third protrusion having an embossing structure.

According to an embodiment of the present disclosure, a bush may include a side stopper portion having an upper plate and a lower plate, a main body portion having an inner pipe and an outer pipe, and a housing portion configured to couple the side stopper portion to the main body portion, and the side stopper portion and the main body portion may be coupled to prevent relative rotation.

The side stopper portion may include a first shock absorbing portion, and the first shock absorbing portion may be provided between the upper plate and the lower plate.

The main body portion may include a second shock absorbing portion, and the second shock absorbing portion may be provided between the inner pipe and the outer pipe.

The first shock absorbing portion and the second shock absorbing portion may be formed of materials having different properties.

The lower plate may be coupled to an end of the outer pipe.

The lower plate may include at least one indented portion formed along a circumferential surface.

One end of the outer pipe may include at least one second protrusion inserted into the indented portion.

The housing portion may further include a fixed portion bent in a “U” shape surrounding an external peripheral surface of the lower plate of the side stopper portion.

The main body portion may further include a third shock absorbing portion protruding toward an opposite side of the side stopper portion.

The third shock absorbing portion may further include a third protrusion having an embossing structure.

According to an example embodiment of the present disclosure, a detachable bush may design and combine a side stopper portion and a main body portion according to the characteristics of a vehicle by improving the side stopper portion and the main body portion, respectively.

In addition, according to an example embodiment of the present disclosure, cracks occurring in a shock absorbing portion at a side stopper portion may not propagate to a shock absorber disposed in a main body portion.

In addition, according to an example embodiment of the present disclosure, NVH (noise, vibration, harshness) performance may be improved by improving the performance of a side stopper portion and a main body portion.

In addition, according to an example embodiment of the present disclosure, a side stopper portion and a main body portion may be fixed so as not to rotate with each other.

### BRIEF DESCRIPTION OF THE DRAWINGS

The above and other aspects, features, and advantages of embodiments of the present disclosure will be more clearly understood from the following detailed description, taken in conjunction with the accompanying drawings, in which:

FIG. 1 is a view illustrating a coupled torsion beam axle (CTBA) equipped with a bush according to an example embodiment of the present disclosure;

FIG. 2 is a perspective view of a bush according to an example embodiment of the present disclosure;

FIG. 3 is a cross-sectional view taken along line I-I′ of FIG. 2;

FIG. 4 is a cross-sectional view taken along line II-II′ of FIG. 2;

FIG. 5 is an exploded view of a bush according to an example embodiment of the present disclosure;

FIG. 6 is a perspective view of a lower plate of a side stopper portion according to an example embodiment of the present disclosure;

FIG. 7 is a perspective view of an outer pipe of a main body portion according to an example embodiment of the present disclosure; and

FIG. 8 is a perspective view in a state in which a lower plate of a side stopper portion and an outer pipe of a main body portion are coupled according to an example embodiment of the present disclosure.

### DETAILED DESCRIPTION OF ILLUSTRATIVE EMBODIMENTS

Hereinafter, embodiments of the present disclosure may make various changes and have various embodiments, specific embodiments thereof will be described and illustrated in the drawings. However, the specific embodiments are not intended for limiting the embodiments of the invention. The idea of embodiments of the present disclosure should be construed to extend to any alterations, equivalents, and substitutes besides the accompanying drawings.

It will be understood that although the terms first, second, etc. may be used herein to describe various elements, these elements should not be limited by these terms. These terms are generally only used to distinguish one element from another. For example, a first element could be termed a second element, and, similarly, a second element could be termed a first element, without departing from the scope of the embodiments of the present disclosure. The term and/or encompasses a combination of plural items or any one of the plural items.

The terms used herein are for the purpose of describing particular embodiments only and are not intended to be limiting of the embodiments of the present disclosure. The singular also includes the plural unless specifically stated otherwise in the phrase. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which example embodiments of the present disclosure belong. It will be further understood that the terms, such as those defined in commonly used dictionaries, should be interpreted as having meanings that are consistent with their meanings in the context of the relevant art and will not be interpreted in an idealized or overly formal sense unless expressly so defined herein.

Hereinafter, embodiments of the present disclosure will be described with reference to the attached drawings.

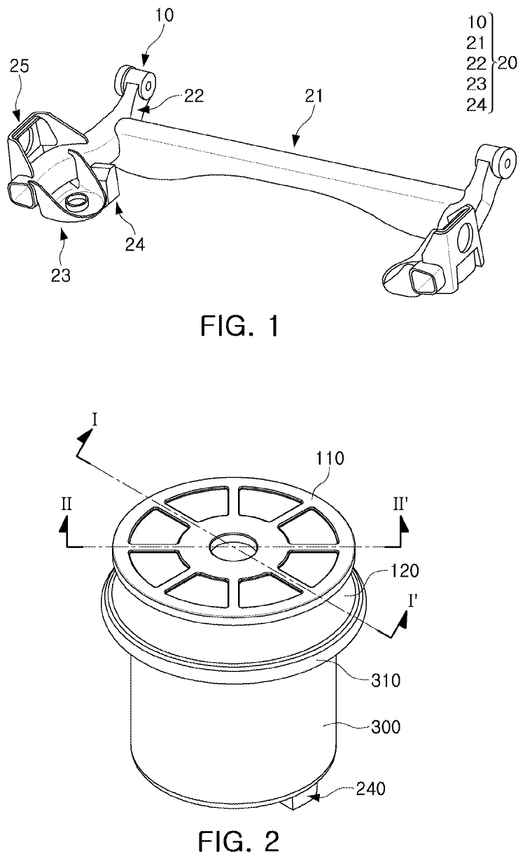

FIG. 1 is a view illustrating a coupled torsion beam axle (CTBA) 20 equipped with a bush 10 according an example embodiment of the present disclosure.

The CTBA 20 may include a torsion beam 21, a trailing arm 22, a spring seat 23, a shock absorber bracket 24, and the bush 10, e.g., a hydro-bush.

The torsion beam 21 may be disposed between a left wheel and a right wheel to extend in a width direction of a vehicle body. For example, the torsion beam 21 may be mounted on a left rear wheel and a right rear wheel, but the embodiments of the present disclosure are not limited thereto.

The torsion beam 21 may suppress an independent movement of the trailing arms 22 which are provided on a left side and a right side of the torsion beam 21 and to which wheels of the vehicle body are connected, using torsional elastic force.

The trailing arms 22 may be provided on both ends of the torsion beam 21 in a length direction of the vehicle body. The trailing arm 22 may have a spindle bracket 25 fixed to an external side surface in a width direction of the vehicle body to mount wheels of the vehicle body.

The trailing arm 22 may be coupled to the spring seat 23 equipped with a spring and the shock absorber bracket 24 equipped with a shock absorber and may support the spring seat 23 and the shock absorber bracket 24.

In the event of vibrations or shocks in the vehicle body, vibrations and shocks transmitted from the ground to the vehicle body may be absorbed by a spring (not illustrated) and a shock absorber (not illustrated).

The trailing arm 22 may be supported on the vehicle body through the bush 10 provided at a front end of the vehicle body.

The bush 10 may control vibrations and shocks to prevent vibrations and shocks from being transmitted to the vehicle body. The bush 10 may prevent vibrations and shocks from being transmitted to the vehicle body using buffering characteristics of rubber.

The bush 10 according an example embodiment of the present disclosure may be in a form in which a side stopper portion 100 and a main body portion 200 are coupled by a housing portion 300.

The bush 10 according to a conventional art is integrally provided with a side stopper portion 100 and a main body portion 200. When cracks occur in the side stopper portion 100 of the integral bush 10, a problem may occur in which the cracks may propagate to the main body portion 200.

Furthermore, efforts are being made to improve the durability of the side stopper portion 100 by increasing the hardness of materials (e.g., rubber) of a shock absorbing portion, but unfortunately the performance of the bush 10 for absorbing vibrations and absorbing shock has been deteriorated.

The bush 10 according to an example embodiment of the present disclosure may be manufactured by separating the side stopper portion 100 and the main body portion 200, and as each of the side stopper portion 100 and the main body portion 200 is provided with a shock absorbing portion, the side stopper portion 100 and the main body portion 200 may be individually optimized according to respective functions and purposes thereof, thereby improving the durability of the bush 10 as well as functionality thereof.

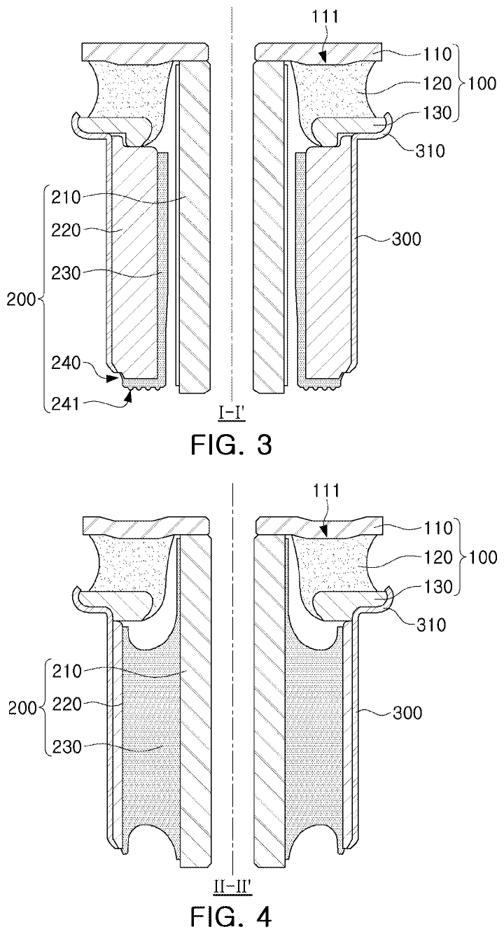

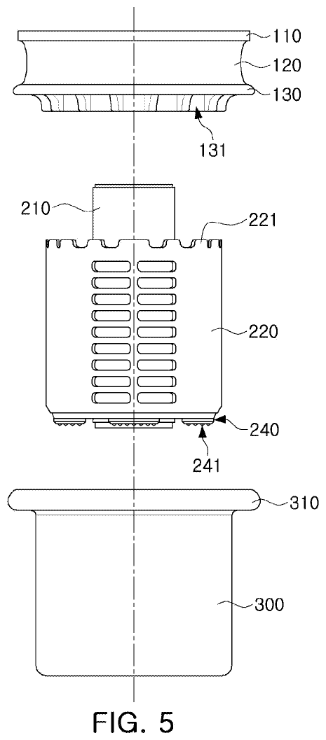

FIG. 2 is a perspective view of a bush 10 according to an example embodiment of the present disclosure, FIG. 3 is a cross-sectional view taken along line I-I′ of FIG. 2, FIG. 4 is a cross-sectional view taken along line II-II′ of FIG. 2, and FIG. 5 is an exploded view of the bush 10 according to an example embodiment of the present disclosure.

Referring to FIGS. 2 to 5, the bush 10 according an example embodiment of the present disclosure may include the side stopper portion 100, the main body portion 200, and the housing portion 300.

The side stopper portion 100 may include an upper plate 110 and a lower plate 130 and a first shock absorbing portion 120 provided between the upper plate 110 and the lower plate 130. The side stopper portion 100 may have a toroid shape having a hole in a center thereof as a whole.

The upper plate 110 may be a circular plate having a hole formed in a central portion thereof. The hole in the central portion may be smaller than at least an external diameter of an inner pipe 210.

A thickness of at least a portion of the upper plate 110 may not be constant in a section between an external circumference and an internal circumference.

For example, thicknesses of the internal circumference of the upper plate 110 and the external circumference thereof are substantially identical to each other, and in a section between the internal circumference and the external circumference, the upper plate 110 may protrude toward a lower surface bonded to the first shock absorbing portion 120, which may be formed to be thicker. Here, a portion protruding to the lower surface of the upper plate 110 may be referred to as a first protrusion ill.

By including the first protrusion 111, the upper plate 110 may be more firmly coupled to the first shock absorbing portion 120 coupled to a lower surface of the upper plate 110, thereby increasing rigidity against shock in the left and right directions.

Furthermore, by including the first protrusion 111, the upper plate 110 may reduce the hardness of the first shock absorbing portion 120, and with the reduction of the hardness of the first shock absorbing portion 120, a buffering effect of the side stopper portion 100 may be increased, thereby improving the NVH (noise, vibration, harshness) performance of the bush 10.

The lower plate 130 may be formed opposite the upper plate 110, and similarly to the upper plate 110, the lower plate 130 may have a toroid shape having a hole in a center thereof. Unlike an internal hole of the upper plate 110, an internal hole of the lower plate 130 may be larger than the external diameter of the inner pipe 210.

More specifically, an upper surface of the lower plate 130 may be coupled to the shock absorbing portion at a predetermined interval from an external circumference thereof. An external circumferential surface of the lower plate 130 may be connected to surround a “U”-shaped fixed portion 310 of the housing portion 300 to be described below.

The first shock absorbing portion 120 may be provided between the upper plate 110 and the lower plate 130. Similarly to the upper plate 110 and the lower plate 130, the shock absorbing portion may have a toroid shape having a hole in a center thereof.

Furthermore, unlike the internal hole of the upper plate 110, an internal hole of the first shock absorbing portion 120 may be larger than the external diameter of the inner pipe 210. The first shock absorbing portion 120 may be formed of a material having a predetermined elasticity, such as a material of rubber or a synthetic resin.

The main body portion 200 may include the inner pipe 210, an outer pipe 220, and a second shock absorbing portion 230.

The inner pipe 210 may be coupled to a vibration-proof portion on an external surface thereof and may have a hollow shape to be coupled to a frame of a vehicle body. The inner pipe 210 may be coupled to the second shock absorbing portion 230 with one side thereof protruding by a thickness of the side stopper portion 100 so that the inner pipe 210 may be inserted into and coupled to the side stopper portion 100.

The protruding inner pipe 210 may be coupled to the housing portion 300 while being inserted into an internal hole of the side stopper portion 100, and the side stopper portion 100 may be fixed to the vehicle body together with the main body portion 200.

Here, the inner pipe 210 may be formed to protrude by a length of a sum of the thicknesses of the lower plate 130 and the first shock absorbing portion 120 of the side stopper portion 100 and may be inserted into the side stopper portion 100. In other words, the inner pipe 210 may protrude so that an end surface of the inner pipe 210 inserted into the side stopper portion 100 is in contact with the upper plate 110 of the side stopper portion 100.

On the other hand, in a case in which a protruding length of the inner pipe 210 is formed to be longer than thicknesses of the lower plate 130 and the shock absorbing portion of the side stopper portion 100, an end of the inner pipe 210 when coupled to the side stopper portion 100 may apply force for pushing the upper plate 110 outwardly, thus deforming the upper plate 110 or weakening a contact between the upper plate 110 and the first shock absorbing portion 120.

Conversely, in a case in which the protruding length of the inner pipe 210 is formed to be shorter than the thicknesses of the lower plate 130 and the shock absorbing portion of the side stopper portion 100, within a distance in which an end of the inner pipe 210 and the upper plate 110 are spaced apart from each other, the inner pipe 210 and the upper plate 110 may move relatively freely until the inner pipe 210 is in contact with the upper plate 110, which may deteriorate the performance of the side stopper portion 100 and the bush 10.

Accordingly, the end of the inner pipe 210 may be formed to come into contact with the upper plate 110, thereby minimizing a change of the upper plate 110 while maintaining the performance of the bush 10.

The second shock absorbing portion 230 may be provided between the inner pipe 210 and the outer pipe 220 and may be made of elastic rubber or synthetic resin so as to absorb shocks and vibrations generated by the side stopper portion 100 or the inner pipe 210.

The outer pipe 220 may be coupled to the second shock absorbing portion 230 in an internal surface thereof and may have a hollow cylindrical shape. In other words, a second shock absorber may be provided between the outer pipe 220 and the inner pipe 210.

One side of the outer pipe 220 may be coupled so as not to rotate with the side stopper portion, and the other side thereof may include a third shock absorbing portion 240.

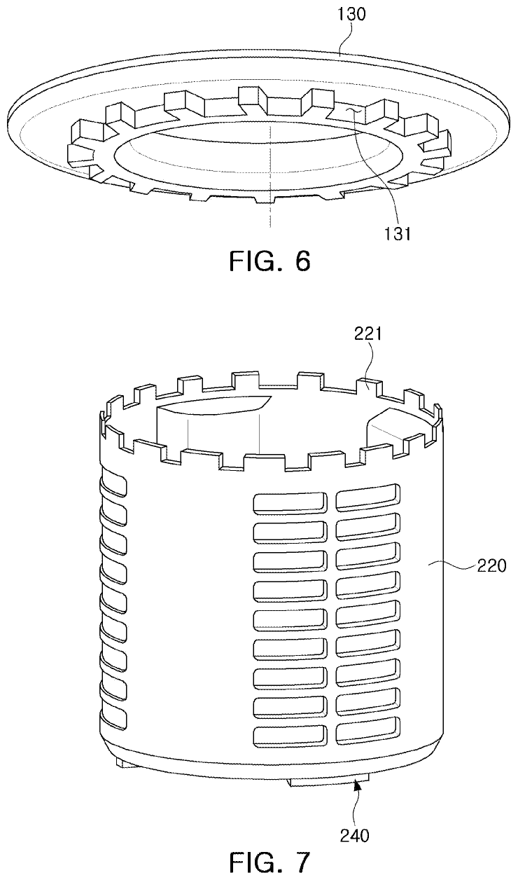

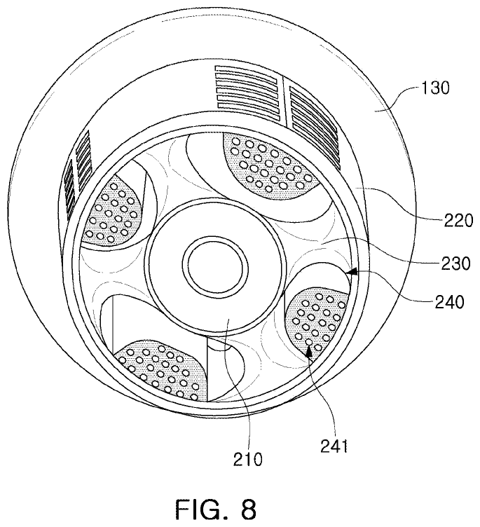

FIG. 6 is a perspective view of the lower plate 130 of the side stopper portion 100 according to an example embodiment of the present disclosure, FIG. 7 is a perspective view of the outer pipe 220 of the main body portion 200 according to an example embodiment of the present disclosure, and FIG. 8 is a perspective view in a state in which the lower plate 130 of the side stopper portion 100 and the outer pipe 220 of the main body portion 200 are coupled according to an example embodiment of the present disclosure.

A coupling structure between the side stopper portion 100 and the main body portion 200 will be described with reference to FIGS. 6 to 8.

The side stopper portion 100 and the main body portion 200 may be coupled so as not to rotate with each other. In a bush 10 according to embodiments of the present disclosure, the side stopper portion 100 and the main body portion 200 may be discontinuously manufactured, and the side stopper portion 100 and the main body portion 200 may be supported by the fixed portion 310 of the housing portion 300 to be described below.

On the other hand, since the housing portion 300 cannot prevent relative rotation of the side stopper portion 100 and the main body portion 200, the side stopper portion 100 and the main body portion 200 may rotate when shocks or repeated vibrations occur in the bush 10, which may cause a change in the performance of the bush 10.

Referring back to FIGS. 6 to 8, the side stopper portion 100 and the main body portion 200 may be coupled so as not to rotate with each other. More specifically, the lower plate 130 of the side stopper portion 100 may be coupled to one end of the outer pipe 220 of the main body portion 200.

Referring to FIG. 6, the lower plate 130 of the side stopper portion 100 may further include an indented portion 131, and a second protrusion 221 may be further included in one end of the outer pipe 220 of the main body portion 200.

Furthermore, the side stopper portion 100 and the main body portion 200 may be coupled so that the second protrusion 221 of the outer pipe 220 is inserted into the indented portion 131 of the lower plate 130, so that the side stopper portion 100 and the main body portion 200 may not rotate despite external shocks or vibrations.

At least one indented portion 131 may be provided on a lower surface of the lower plate 130 of the side stopper portion 100. The indented portion 131 may be formed to correspond to the second protrusion 221 provided on a circumferential surface of the outer pipe 220 of the main body portion 200.

The second protrusion 221 may have at least one protrusion provided in one end of the main body portion 200. The second protrusion 221 may be inserted into the indented portion 131 of the side stopper portion 100.

In other words, the second protrusion 221 of the main body portion 200 and the indented portion 131 of the side stopper portion 100 may have shapes and positions corresponding to each other, and the second protrusion 221 may be inserted into the indented portion 131 and assembled to be engaged like a sawtooth.

Accordingly, the main body portion 200 and the side stopper portion 100 may not rotate each other even by external shocks or repeated vibrations due to the second protrusion 221 and the indented portion 131 engaged with each other.

A third shock absorbing portion 240 may be provided in the other side of the outer pipe 220 in a direction oriented toward the side stopper portion 100. In other words, the outer pipe 220 may have the second protrusion 221 provided at one end thereof and the third shock absorbing portion 240 provided at the other end thereof.

When a large load acts on the bush 10, the third shock absorbing portion 240 controls displacement together with the side stopper portion 100. The side stopper portion 100 and the third shock absorbing portion 240 may control the displacement on both sides thereof, thereby reducing the load of the first shock absorbing portion 120 to the second shock absorbing portion 230 and improving the durability of the bush 10.

Here, the third shock absorbing portion 240 may further include a plurality of third protrusions 241 protruding in the form of embossing.

On the other hand, the third shock absorbing portion 240 may improve the durability of the bush 10, but may reduce the NVH performance of the bush 10 by generating noise such as buzzing, squeaking, and rattling noises due to friction with a vehicle body.

Accordingly, the third shock absorbing portion 240 may further include an embossed third protrusion 241, thereby improving the NVH performance of the bush 10 by reducing noise generation.

The housing portion 300 may be formed in a hollow cylindrical shape and may couple the side stopper portion 100 and the main body portion 200. A hollow hole in a lower portion of the housing portion 300 may be smaller than an external diameter of the outer pipe 220 of the main body portion 200, and a hollow hole in an upper portion thereof may be smaller than an external diameter of the lower plate 130 of the side stopper portion 100.

The housing portion 300 may further include a fixed portion 310 bent in a “U” shape. The fixed portion 310 formed along the circumferential surface of the housing portion 300 may press the lower plate 130 toward the main body portion 200 to couple the side stopper portion 100 and the main body portion 200, in a state in which an edge of a hollow disk-shaped lower plate 130 of the side stopper portion 100 is disposed inside the “U” shape.

In the conventional bush 10, the side stopper portion 100 is directly coupled through the inner pipe 210, but the bush 10 according to an example embodiment of the present disclosure may be formed by separating the side stopper portion 100 and the main body portion 200 and may have a shape in which the side stopper portion 100 and the main body portion 200 may be restrained by the housing portion 300.

Accordingly, the first shock absorbing portion 120 provided in the side stopper portion 100 and the second shock absorbing portion 230 provided in the main body portion 200 may be formed of different materials and may be assembled through the housing portion 300 after having materials suitable for each characteristic.

For example, in the conventional bush 10, when the hardness of the material of the shock absorbing portion increases to increase the durability of the side stopper portion 100, the NVH may be reduced by affecting the main body portion 200 including the integrally formed inner pipe 210, or cracks in the shock absorbing portion may be transmitted to the main body portion 200. Specifically, in the case of the shock absorbing portion, an increase in durability thereof may conversely deteriorate the NVH performance, which may cause the durability and the NVH performance to be inversely proportional to each other.

In contrast, in the bush 10 according to an example embodiment of the present disclosure, the side stopper portion 100 and the main body portion 200 may be separately manufactured, and since the side stopper portion 100 and the main body portion 200 are coupled through the housing portion 300, cracks in the side stopper portion 100 may not be transmitted to the main body portion 200.

Specifically, the bush 10 according to an example embodiment of the present disclosure may simultaneously improve the durability and the NVH performance by separately designing the side stopper portion 100 and the main body portion 200.

For example, the NVH performance of the material of the first shock absorbing portion 120 of the side stopper portion 100 may be improved using a high elastic material, and the durability of the material of the second shock absorbing portion 230 of the main body portion 200 may be improved using a material resistant to fatigue.

In addition, the main body portion 200 and the side stopper portion 100 may be coupled to the protrusions and the indented portion 131 engaged with each other, so that the main body portion 200 and the side stopper portion 100 as discontinuously formed may not rotate with each other even by external shocks or repeated vibrations.

Table 1 below is a table illustrating performance test results of the bush according to the conventional art and the bush according to an example embodiment of the present disclosure.

Here, the bush according to the conventional art may be a bush in which the shock absorbing portions of the main body portion and the side stopper portion are integrally formed.

In addition, the bush according to an example embodiment of the present disclosure in Table 1 below and the bush according to the conventional art applied rubber of the same material (e.g., Hs65). In other words, the bush according to an example embodiment of the present disclosure was manufactured by separating the shock absorbing portion of the side stopper portion from the shock absorbing portion of the main body portion and was formed of rubber of the same material.

TABLE 1

| | | | Example Embodiment |
|---|---|---|---|
| | | Conventional | of the Present |
| Division | Target Value | Art | Disclosure |
| P1 | 80 ↓ | 86.8 | 72.7 |
| P2 | 60 ↓ | 96.4 | 56.5 |
| Q | 145↑ | 159.3 | 157.6 |

In Table 1, P1 may be a value for the buffer capacity in a front-rear direction of a vehicle, P2 may be a value for the buffer capacity in a vertical direction of the vehicle, and Q may be a value for the buffer capacity in a left-right direction of the vehicle.

Here, as the P1 decreases, the ride comfort may increase, and as the P2 decreases, the NVH may be improved, and also, as the Q increases, the handling of the vehicle, that is, the driving performance, may be improved.

Referring to Table 1, the P1 and Q values of the bush according to the conventional art are similar to a target value, but the P2 value may differ greatly from a target value. When the shock absorbing portion according to the conventional art is integrally formed, it was difficult to satisfy all P1, P2, and Q values.

When one property was improved, the other property was weakened, and accordingly, the ride comfort, the NVH, and the handling were inevitably improved selectively.

Meanwhile, the detachable bush according to an example embodiment of the present disclosure shows that all P1, P2, and Q values may be satisfied only by separating the shock absorbing portions of the side stopper portion and the main body portion.

Accordingly, the materials of the shock absorbing portion may be applied differently according to the type and characteristics of the load acting on the side stopper portion and the main body portion, thereby further improving the P1, P2, and Q values.

While example embodiments have been illustrated and described above, it will be apparent to those skilled in the art that modifications and variations could be made without departing from the scope of the embodiments of the present disclosure as defined by the appended claims.

What is claimed is:

1. A bush comprising:
a side stopper portion comprising a first shock absorbing portion;
a main body portion comprising a second shock absorbing portion, wherein the first shock absorbing portion and the second shock absorbing portion are provided discontinuously; and
a housing portion configured to couple the side stopper portion to the main body portion.

2. The bush according to claim 1, wherein a material of the first shock absorbing portion and a material of the second shock absorbing portion have different properties.

3. The bush according to claim 1, wherein the side stopper portion comprises an upper plate and a lower plate, and wherein the first shock absorbing portion is disposed between the upper plate and the lower plate.

4. The bush according to claim 3, wherein the main body portion comprises an inner pipe protruding from a first end, and wherein a protrusion of the inner pipe is inserted into the side stopper portion.

5. The bush according to claim 4, wherein an end of the protrusion of the inner pipe is in contact with the upper plate.

6. The bush according to claim 3, wherein the upper plate further comprises a first protrusion protruding toward the first shock absorbing portion.

7. The bush according to claim 3, wherein the housing portion further comprises a fixed portion bent in a “U” shape surrounding an external peripheral surface of the lower plate.

8. The bush according to claim 1, wherein the main body portion further comprises a third shock absorbing portion protruding from a side of the main body portion opposite the side stopper portion.

9. The bush according to claim 8, wherein the third shock absorbing portion further comprises a third protrusion having an embossing structure.

10. A bush comprising:
a side stopper portion comprising an upper plate and a lower plate;
a main body portion comprising an inner pipe and an outer pipe; and
a housing portion configured to couple the side stopper portion to the main body portion, wherein the side stopper portion and the main body portion are coupled such that relative rotation is prevented.

11. The bush according to claim 10, wherein the side stopper portion comprises a first shock absorbing portion disposed between the upper plate and the lower plate.

12. The bush according to claim 11, wherein the main body portion comprises a second shock absorbing portion disposed between the inner pipe and the outer pipe.

13. The bush according to claim 12, wherein the first shock absorbing portion and the second shock absorbing portion are formed of materials having different properties.

14. The bush according to claim 10, wherein the lower plate is coupled to a first end of the outer pipe.

15. The bush according to claim 14, wherein the lower plate comprises an indented portion disposed along a circumferential surface.

16. The bush according to claim 15, wherein the first end of the outer pipe comprises a second protrusion inserted into the indented portion.

17. The bush according to claim 10, wherein the housing portion further comprises a fixed portion bent in a “U” shape surrounding an external peripheral surface of the lower plate of the side stopper portion.

18. The bush according to claim 10, wherein the main body portion further comprises a third shock absorbing portion protruding from a side of the main body portion opposite the side stopper portion.

19. The bush according to claim 18, wherein the third shock absorbing portion further comprises a third protrusion having an embossing structure.

20. A bush comprising:
a side stopper portion comprising an upper plate, a lower plate, and a first shock absorbing portion disposed between the upper plate and the lower plate, wherein the lower plate comprises an indented portion disposed along a circumferential surface;
a main body portion comprising an inner pipe, an outer pipe comprising a protrusion, and a second shock absorbing portion disposed between the inner pipe and the outer pipe; and
a housing portion coupling the side stopper portion to the main body portion, wherein, in a state in which the main body portion is coupled to the side stopper portion, a protruding end of the inner pipe is inserted into and coupled to the side stopper portion with the protruding end of the inner pipe in contact with the upper plate of the side stopper portion, and the protrusion of the outer pipe is inserted into the indented portion in the lower plate.
